(19) United States
(12) Patent Application Publication
(10) Pub. No.: US 2009/0021654 A1
(43) Pub. Date: Jan. 22, 2009

(54) Self-contained entertainment system

(76) Inventor: Rebb Jones, Tacoma, WA (US)

Correspondence Address: Kevin Steinacker, Ste. 1401, 1201 Pacific Ave., Tacoma, WA, 98402, US

(21) Appl. No.: 11/810,923

(22) Filed: Jun. 7, 2007

Related U.S. Application Data
(60) Provisional application No. 60/811,658, filed on Jun. 7, 2006.

(51) Int. Cl. H04N 5/64

(52) U.S. Cl. 348/838; 348/836; 348/E05.129

(57) ABSTRACT

The present invention provides a self-contained entertainment system that includes a housing having a main compartment and a lid. The main compartment is comprised of a bottom and four sidewalls arranged to form an interior cavity. One or more media sources, a video display, and one or more audio outputs are located within the housing. The media source, the video display, and the audio output are operably connected to each other by means of wires and/or wireless technology. The media source, the video display, and the audio output receive power by appropriate means from a power supply.

### PRIORITY

The applicant claims priority from a Provisional Patent Application filed on Jun. 7, 2006, under Application No. 60/811,658.

### FEDERALLY SPONSORED RESEARCH

N/A

### FIELD OF THE INVENTION

The present invention generally relates to a self-contained, transportable entertainment system, and more particularly to an entertainment system having specifically all the necessary hardware, components, and accessories included into a fully-enclosable, protective casing.

### BACKGROUND OF THE INVENTION

There is a great desire for mobile methods of providing entertainment. Several transportable media apparatus are known, such as the video cart disclosed in U.S. Pat. No. 4,755,881 to Bartlett, the audio system disclosed in U.S. Pat. No. 6,968,067 to Lopez, and the video system disclosed in US Des. Pat. No. 310,075 to Mannion, et al. It is also common to find media devices that are portable because of their size, such as handheld video game systems and portable DVD players. In addition, audio systems have been incorporated into portable storage containers, as disclosed in U.S. Pat. No. 5,781,853 to Johnson and U.S. Pat. No. 5,979,175 to Ellison, for example.

However, all prior art portable media apparatus have several disadvantages. The systems are generally too small, difficult to handle, or fragile. The video and audio output may be small and/or insufficient for an immersive media experience. Furthermore, prior art devices may be unsuitable for modern electronic devices which require means to provide adequate airflow and heat dissipation. Prior art devices also may not have adequate security measures to protect against theft of the valuable components. Another disadvantage of prior apparatus is that they do not have sufficient space to conveniently store the hardware, components, cables, and accessories required for a complete entertainment system.

Thus, there is a need for a transportable entertainment system that can be moved easily and contains all of the necessary components for a complete entertainment system, including adequate audio output and video display and sufficient physical space to store other necessary elements. There is also a need for such a self-contained entertainment system that has means to circulate air and dissipate heat generated by the electronic components when in use and that incorporates means to protect the components from damage and theft. The present invention fulfills this and other needs.

### SUMMARY OF THE INVENTION

The general purpose of the present invention, which will be described subsequently in greater detail, is to provide a complete and portable entertainment system suitable for use in virtually any location, while still including the necessary hardware, software, components, and accessories in a single unit.

A self-contained entertainment system is provided that includes a housing having a main compartment and a lid. The main compartment is comprised of a bottom and four sidewalls arranged to form an interior cavity. One or more media sources, a video display, and one or more audio outputs are located within the housing. The media source, the video display, and the audio output are operably connected to each other by means of wires and/or wireless technology. The media source, the video display, and the audio output receive power by appropriate means from a power supply.

In addition to the elements described above, the lid in an alternate embodiment of the unit is attached to the main compartment at one or more hinges. The unit also has a lock attached to the lid to secure the unit when the lid is closed. Means to transport the unit, such as wheels, are attached to the housing. One or more handles are also attached to the housing. The video display is attached to an inside surface of the lid, and the media source and audio outputs are located in the main compartment.

Another alternate embodiment has as additional elements an adjustable strap attached to the main compartment and the lid to hold the lid open at a desired angle, a fan in the main compartment and one or more vents in the sidewalls, and pockets attached to the sidewalls for storage within the main compartment.

The above summary of the present invention is not intended to represent each embodiment, or every aspect, of the present invention. The present invention also includes any additional features and benefits which are apparent from the detailed description and figures set forth below.

### BRIEF DESCRIPTION OF THE FIGURES

FIG. 1 is a perspective view of the self-contained entertainment system with the lid in an open position and a portion of two sidewalls cut away to show the interior.

FIG. 2 is a perspective view of the self-contained entertainment system with the lid in a closed position.

FIG. 3 is a perspective view of the rear of the self-contained entertainment system with the lid in a closed position.

FIG. 4 is a side view of the self-contained entertainment system with the lid in an open position.

FIG. 5 is a top view of the self-contained entertainment system with the lid in an open position, but does not depict the components located within the interior cavity.

FIG. 6 is a cross sectional view of the self-contained entertainment system taken along the line 6-6 in FIG. 4.

FIG. 7 is a perspective view of another embodiment of the self-contained entertainment system with the lid in an open position

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as described.

### DETAILED DESCRIPTION OF THE ILLUSTRATED EMBODIMENTS

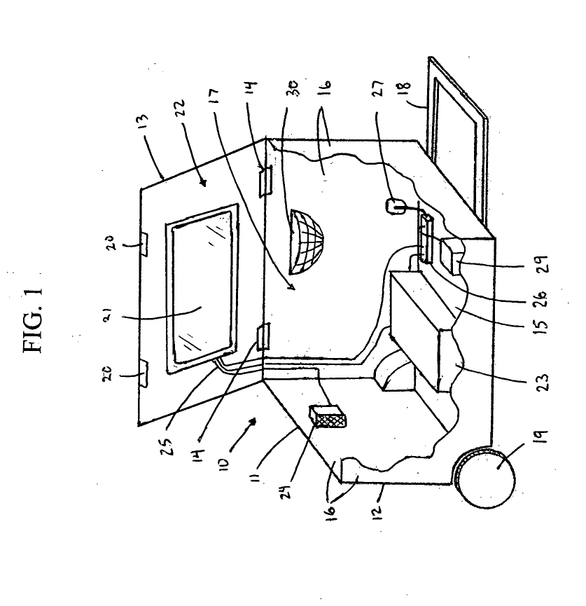

Referring to FIG. 1, a self-contained entertainment system (10) includes a housing (11), comprised of a main compartment (12) and a lid (13), the lid (13) being attached to the main compartment (12) by one or more hinges (14). The main compartment (12) has a bottom (15) and four sidewalls (16), the bottom (15) and sidewalls (16) being arranged so that they form an interior cavity (17). A retractable handle (18) and wheels (19) are attached to the housing (11), and a locking mechanism (20) is attached to the lid (13). A video display (21) is securely attached to an interior surface (22) of the lid (13). One or more media sources (23) are positioned within the interior cavity (17). One or more audio outputs (24) are securely attached to the sidewalls (16). The video display (21), media sources (23), and audio outputs (24) are connected to one another by means of wires (25). The video display (21), media sources (23), and audio outputs (24) are also connected to a power strip (26), which is in turn connected to an electrical port (27) located in one sidewall (16). The electrical port (27) is comprised of means to provide an electrical connection through the sidewall (16), and may take the form of a standard electrical outlet from the interior and have a connection (usually male) on the exterior where a power cord may be plugged in. An external power source is connected to the electrical port (27) to provide electricity to the system. A fan (29) is positioned within the interior cavity (17) and connected to the power strip (26). A pocket (30) is attached to a sidewall (16) within the interior cavity (17).

In the preferred embodiment, the housing is watertight when properly closed, and is constructed of durable material in order to protect the components within from accidental damage. The housing is also of such size and weight that the entire unit is not overly cumbersome. The preferred embodiment also has removable layers of foam padding that are appropriately shaped to be placed within the main compartment to reduce the likelihood of damage during transport. Straps may also be provided to secure the electrical components in place.

In the preferred embodiment, the video display is a flat panel monitor capable of receiving and displaying input from multiple sources. The media source or sources may include such equipment as a DVD player, a cable box, satellite receiver or other source of television signals, a VHS player, a video game console, a camera, a camcorder, a CD player, an MP3 player, a computer, or a wired or wireless means to access the Internet.

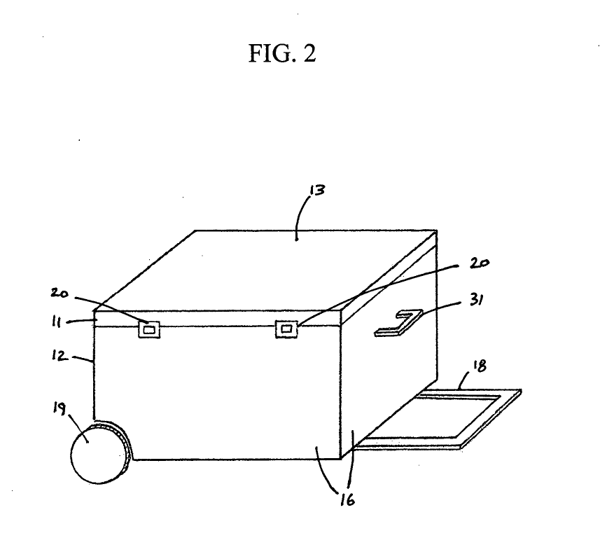

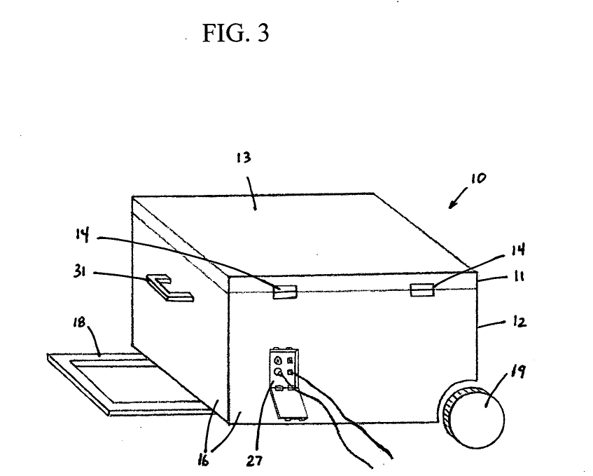

Referring to FIGS. 2 and 3, a self-contained entertainment system (10) includes a housing (11), comprised of a main compartment (12) and a lid (13), the lid (13) being attached to the main compartment (12) by one or more hinges (14). The main compartment (12) has a bottom (15) and four sidewalls (16). A retractable handle (18) and wheels (19) are attached to the housing (11). Folding handles (31) are attached to the sidewalls (16). A locking mechanism (20) is attached to the lid (13). An electrical port (27) is located in one sidewall (16) and may be connected to an external power source to provide electricity to the system.

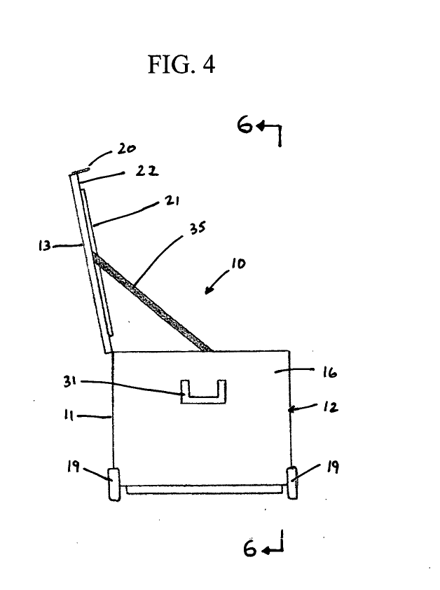

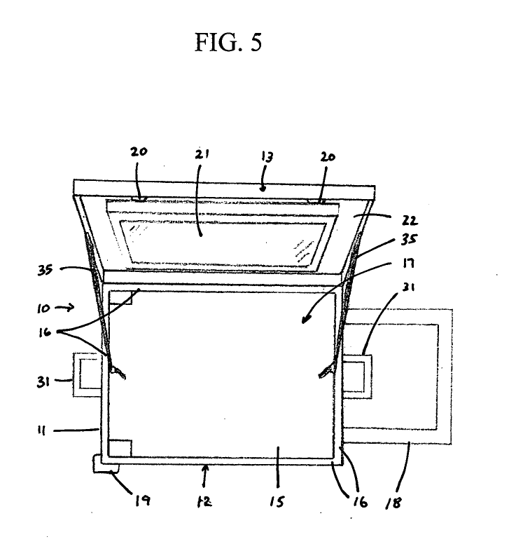

Referring to FIGS. 4 and 5, a self-contained entertainment system (10) includes a housing (11), comprised of a main compartment (12) attached to a lid (13). Adjustable straps (35) are attached to the main compartment (12) and the lid (13) to control the position of the lid (13) when open. The main compartment (12) has a bottom (15) and four sidewalls (16), the bottom (15) and sidewalls (16) forming an interior cavity (17). A retractable handle (18) and wheels (19) are attached to the housing (11). Folding handles (31) are attached to the sidewalls (16). A locking mechanism (20) is attached to the lid (13). A video display (21) is securely attached to an interior surface (22) of the lid (13).

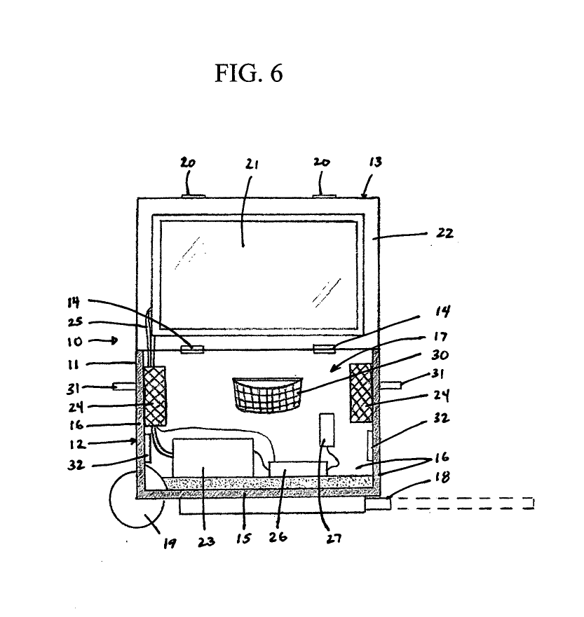

Referring to FIG. 6, a self-contained entertainment system (10) includes a housing (11), comprised of a main compartment (12) and a lid (13), the lid (13) being attached to the main compartment (12) by one or more hinges (14). The main compartment (12) has a bottom (15) and four sidewalls (16), the bottom (15) and sidewalls (16) being arranged so that they form an interior cavity (17). A retractable handle (18) and wheels (19) are attached to the housing (11). Folding handles (31) are attached to the sidewalls (16). A locking mechanism (20) is attached to the lid (13). A video display (21) is securely attached to an interior surface (22) of the lid (13). One or more media sources (23) are positioned within the interior cavity (17). One or more audio outputs (24) are securely attached to sidewalls (16). The video display (21), media sources (23), and audio outputs (24) are connected to one another by means of wires (25). The video display (21), media sources (23), and audio outputs (24) are also connected to a power strip (26), which is in turn connected to an electrical port (27) located in one sidewall (16). An external power source is connected to the electrical port (27) to provide electricity to the system. Vents (32) are positioned within the sidewalls (16). A pocket (30) is attached to a sidewall (16) within the interior cavity (17).

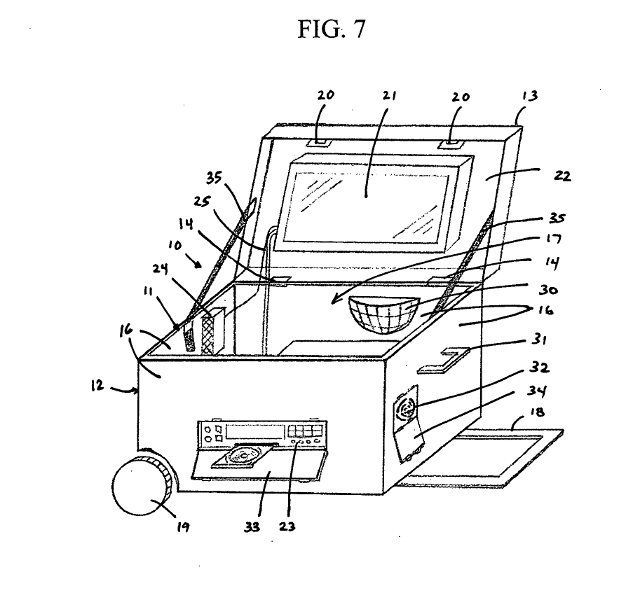

Referring to FIG. 7, a self-contained entertainment system (10) includes a housing (11), comprised of a main compartment (12) and a lid (13), the lid (13) being attached to the main compartment (12) by one or more hinges (14). Adjustable straps (35) are attached to the main compartment (12) and the lid (13) to control the position of the lid (13) when open. The main compartment (12) has a bottom (15) and four sidewalls (16), the bottom (15) and sidewalls (16) being arranged so that they form an interior cavity (17). A retractable handle (18) and wheels (19) are attached to the housing (11). Folding handles (31) are attached to the sidewalls (16). A locking mechanism (20) is attached to the lid (13). A video display (21) is securely attached to an interior surface (22) of the lid (13). One or more media sources (23) are positioned within the interior cavity (17). One or more audio outputs (24) are securely attached to the sidewalls (16). The video display (21), media sources (23), and audio outputs (24) are connected to one another by means of wires (25). An access door (33) in one sidewall (16) provides access to the media source (23). Vents (32) are positioned within the sidewalls (16) and may be covered with a vent door (34). A pocket (30) is attached to a sidewall (16) within the interior cavity (17).

The attached figures depict wires connecting the media source, the video display, and the audio output. In an alternate embodiment, wireless technology may be implemented for one or more of these connections.

In an alternate embodiment, the audio outputs may be attached to the interior surface of the lid. In addition, the audio outputs may be removably attached so that the user can take the outputs out of the inner cavity and position them in various locations to create a surround sound or other effect.

In yet another alternate embodiment, a battery or small generator may be placed within the main compartment as the power supply for the electrical components.

While the invention is susceptible to various modifications and alternative forms, specific embodiments thereof have been shown by way of example in the drawings and herein described in detail. One skilled in the art will recognize suitable substitutions. It should be understood, however, that it is not intended to limit the invention to the particular forms disclosed, but on the contrary, the intention is to cover all modifications, equivalents, and alternatives falling within the spirit and scope of the invention as described.

I claim:

1. A self-contained entertainment system comprising:
a housing comprising a main compartment and a lid, said main compartment comprising a bottom and four sidewalls arranged to form an interior cavity;
at least one media source, a video display, and at least one audio output located within said housing;
connection means to operably connect said media source, said video display, and said audio output; and
power supply means to connect said media source, said video display, and said audio output to an electrical power source.

2. The self-contained entertainment system of claim 1, further comprising: means for transport attached to said housing.

3. The self-contained entertainment system of claim 2, in which said means for transport comprises an axle and a pair of wheels.

4. The self-contained entertainment system of claim 1, further comprising one or more handles attached to said housing.

5. The self-contained entertainment system of claim 1, further comprising a retractable handle attached to said housing.

6. The self-contained entertainment system of claim 1, further comprising means to lock said lid in a closed position covering said main compartment.

7. The self-contained entertainment system of claim 1, in which said video display is securely attached to an interior surface of said lid.

8. The self-contained entertainment system of claim 1, in which said power supply means comprises an electrical port in one of said sidewalls electrically connected to said media source, said video display, and said audio output, said electrical port being removably connected to an external power source.

9. The self-contained entertainment system of claim 1, in which said power supply means comprises a battery electrically connected to said media source, said video display, and said audio output.

10. A self-contained entertainment system, comprising:
a housing comprising a main compartment and a lid hingedly attached to said main compartment, said main compartment comprising a bottom and four sidewalls arranged to form an interior cavity;
means to lock said lid in a closed position covering said main compartment;
means for transport attached to said housing;
one or more handles attached to said housing;
at least one media source and at least one audio output located within said main compartment;
a video display securely attached to an interior surface of said lid;
connection means to operably connect said media source, said video display, and said audio output; and
power supply means to connect said media source, said video display, and said audio output to an electrical power source.

11. The self-contained entertainment system of claim 10, in which said means for transport comprises an axle and a pair of wheels.

12. The self-contained entertainment system of claim 10, further comprising temperature control means to reduce the temperature within the interior cavity.

13. The self-contained entertainment system of claim 12, in which said temperature control means comprises a fan.

14. The self-contained entertainment system of claim 12, in which said temperature control means comprises one or more vents in one or more of said sidewalls.

15. The self-contained entertainment system of claim 10, further comprising storage means within the interior cavity.

16. The self-contained entertainment system of claim 15, in which said storage means comprises one or more pockets attached to one or more of said sidewalls within the interior cavity.

17. The self-contained entertainment system of claim 10, further comprising means to secure said lid in an open position.

18. The self-contained entertainment system of claim 17, in which said means to secure said lid in an open position comprises an adjustable strap attached to said lid and to said main compartment.

19. The self-contained entertainment system of claim 10, further comprising an access door located within one of said sidewalls.

20. A self-contained entertainment system, comprising:
a housing comprising a main compartment and a lid hingedly attached to said main compartment, said main compartment comprising a bottom and four sidewalls arranged to form an interior cavity;
means to lock said lid in a closed position covering said main compartment;
an adjustable strap attached to said lid and to said main compartment;
means for transport attached to said housing;
one or more handles attached to said housing;
at least one media source and at least one audio output located within said main compartment;
a video display securely attached to an interior surface of said lid;
connection means to operably connect said media source, said video display, and said audio output;
power supply means to connect said media source, said video display, and said audio output to an electrical power source;
a fan located within said main compartment and one or more vents in one or more of said sidewalls; and
one or more pockets attached to one or more of said sidewalls within the interior cavity.

21. The self-contained entertainment system of claim 20, further comprising means to protect said media source, said audio output, and said video display.

22. The self-contained entertainment system of claim 21, in which said means to protect said media source, said audio output, and said video display comprises foam padding removably inserted in to said main compartment around said media source, said audio output, and said video display.
